(19) United States
(12) Patent Application Publication
(10) Pub. No.: US 2025/0310646 A1
(43) Pub. Date: Oct. 2, 2025

(54) Fusing Optically Zoomed Images into One Digitally Zoomed Image

(71) Applicant: Google LLC, Mountain View, CA (US)

(72) Inventors: Xiaotong Wu, Los Gatos, CA (US); Chia-Kai Liang, San Jose, CA (US); Wei-Sheng Lai, San Mateo, CA (US); Yichang Shih, Cupertino, CA (US); Deqing Sun, Cambridge, MA (US); Michael Krainin, Arlington, MA (US); Lun-Cheng Chu, Milpitas, CA (US)

(21) Appl. No.: 18/866,056

(22) PCT Filed: May 17, 2022
(86) PCT No.: PCT/US2022/072362

§ 371 Date: Nov. 14, 2024

(51) Int. Cl. H04N 23/69; G06T 5/50; G06T 5/60

(52) U.S. Cl. CPC H04N 23/69; G06T 5/50; G06T 5/60; G06T 2207/10148; G06T 2207/20081; G06T 2207/20221

(57) ABSTRACT

This document describes systems and techniques directed at fusing optically zoomed images into one digitally zoomed image. In aspects, a computing device having at least two cameras and an image-processing manager is configured to receive, from a first camera, a first image at a first optical zoom and, from a second camera, a second image at a second optical zoom different from the first optical zoom. The first and second cameras capture a same scene from different fields of view and different points of view. The image-processing manager receives a desired digital zoom between the first optical zoom and the second optical zoom. Based on the first and second images, the image-processing manager determines an overlap region of the first image in which the second image overlaps the first image. Also based on the first and the second image, the image-processing manager applies a higher resolution than the first image of the second image to the overlap region of the first image to determine a fused image of the scene with the desired digital zoom. The image-processing manager, by applying the disclosed systems and techniques, is effective to provide a fused image of the scene having the desired digital zoom and a higher resolution than the first image within at least a portion of the overlap region.

### BACKGROUND

Modern smartphones, especially modern flagship smartphones, can include more than one camera. One of these cameras may be paired with a wide-angle lens having a wide field of view (FOV) and a reduced, or no, optical zoom (e.g., 0.7×, 1×). Another one of these cameras may be paired with a telephoto lens having a narrow FOV and a high optical zoom (e.g., 4×). Although modern smartphones having these camera options provide users with flexibility and choice, these camera options also introduce significant challenges.

For example, a user of a modern smartphone having a 1× optical zoom camera and a 4× optical zoom camera may wish to take a photograph of a scene at a 3× zoom. In this case, a 3× zoom must be achieved digitally. A common manner to achieve the 3× zoom is to digitally up-sample the scene captured by the 1× optical zoom camera. Unfortunately, this manner can suffer from resolution loss, resulting in a poor photograph and compromising user experience.

### SUMMARY

This document describes systems and techniques directed at fusing optically zoomed images into one digitally zoomed image. In aspects, a computing device having at least two cameras and an image-processing manager is configured to receive, from a first camera, a first image at a first optical zoom and, from a second camera, a second image at a second optical zoom different from the first optical zoom. The first and second cameras capture a same scene from different fields of view and different points of view. The image-processing manager receives a desired digital zoom between the first optical zoom and the second optical zoom. Based on the first and second images, the image-processing manager determines an overlap region of the first image in which the second image overlaps the first image. Also based on the first and the second image, the image-processing manager applies a higher resolution of the second image to the overlap region of the first image to determine a fused image of the scene with the desired digital zoom. The image-processing manager, by applying the disclosed systems and techniques, is effective to provide a fused image of the scene having the desired digital zoom and a higher resolution than the first image within at least a portion of the overlap region. As such, aspects of the disclosed systems and techniques may provide for image enhancement.

In aspects, a method is disclosed that includes: receiving, from first and second cameras, a first image and a second image, respectively, the first image captured at a first optical zoom and the second image captured at a second optical zoom different from the first optical zoom, the first and second cameras having different fields of view and different points of view, the first image and the second image capturing a same scene with the different fields of view and the different points of view; receiving a desired digital zoom, the desired digital zoom between the first optical zoom and the second optical zoom; determining an overlap region of the first image in which the second image overlaps the first image; determining a fused image of the scene with the desired digital zoom, the determining based on the first image and the second image, the determining applying a higher resolution than the first image of the second image to the overlap region of the first image; and providing the fused image of the scene having the desired digital zoom, the fused image of the scene having a higher resolution than the first image within at least a portion of the overlap region.

In aspects, a computing device is disclosed that includes: at least two cameras, the at least two cameras having different optical zooms, different fields of view, and different points of view; one or more processors; and memory storing: instructions that, when executed by the one or more processors, cause the one or more processors to implement an image-processing manager to provide image processing utilizing the at least two cameras and the one or more processors by performing the method of any one of the preceding claims.

The details of one or more implementations are set forth in the accompanying Drawings and the following Detailed Description. Other features and advantages will be apparent from the Detailed Description, the Drawings, and the Claims. This Summary is provided to introduce subject matter that is further described in the Detailed Description. Accordingly, a reader should not consider the Summary to describe essential features or the scope of the claimed subject matter.

### BRIEF DESCRIPTION OF DRAWINGS

The details of one or more aspects for fusing optically zoomed images into one digitally zoomed image are described in this document with reference to the following Drawings, in which the use of same numbers in different instances may indicate similar features or components:

FIG. 1 illustrates an example implementation of an example computing device having a first camera, a second camera, a display, and an image-processing manager configured to fuse optically zoomed images into one digitally zoomed image;

FIG. 2 illustrates an example implementation of the example computing device from FIG. 1, which is configured to fuse optically zoomed images into one digitally zoomed image;

FIG. 3 illustrates an example implementation of the computing device from FIG. 2 in more detail;

FIG. 4 illustrates an example implementation of a setup used for training a machine-learned model;

FIG. 5 illustrates an example implementation of the setup used for training the machine-learned model from FIG. 4 in more detail;

FIG. 6 illustrates an example implementation of a scene of a cube captured by three different cameras used in training the machine-learned model;

FIG. 7 illustrates an example implementation of a course alignment operation used in training the machine-learned model;

FIG. 8 illustrates an example implementation of a fine alignment operation and an occlusion mask operation used in training the machine-learned model;

FIG. 9 illustrates an example implementation of different depths of field of a camera having a high optical zoom and a camera having a low optical zoom; and

FIG. 10 depicts an example method for fusing optically zoomed images into one digitally zoomed image.

### DETAILED DESCRIPTION

### Overview

Modern computing devices (e.g., smartphones, tablets) often include more than one camera. The inclusion of more than one camera provides options, often desirable for a good user experience, to a user of the modern computing device. The provided options can include a low-light capability, a wide field of view (FOV) with low optical zoom, a narrow FOV with a high optical zoom, a high rate of frame capture, and so forth. The low-light capability option excels at nighttime and twilight photography. The wide FOV with the low optical zoom excels at selfies and close-up photography. The narrow FOV with the high optical zoom excels at wildlife or other distant-object photography. The high rate of frame capture aids in slow-motion videography.

As a specific example, assume that a user of a smartphone, which has two cameras, wishes to capture a scene of bright green leaves on a branch of a tree. The first camera is paired with a lens configured to provide a 1× optical zoom and a wide field of view (FOV). The second camera is paired with a lens configured to provide a 4× optical zoom and a narrow FOV. Also assume that in the background of the scene is a mountain range. The user could capture the scene using the second camera having the 4× optical zoom and narrow FOV. However, the user wishes to include more of the mountain range in the scene, so the narrow FOV is not ideal. Alternatively, the user could capture the scene using the first camera having the 1× optical zoom and the wide FOV. However, the user wishes to include at least some of the finer details of the bright green leaves in the scene, so the 1× optical zoom is not ideal. Rather, the user selects a digital zoom in between the first optical zoom and the second optical zoom (e.g., 3×), taps a viewfinder of the smartphone to set a focus region around the bright green leaves, and taps a shutter button to capture the scene.

Because the user selected the desired digital zoom of 3×, the scene cannot be captured natively by the first camera at the 1× optical zoom or the second camera at the 4× optical zoom. Rather, the scene can be captured by the first camera at the 1× optical zoom and a resulting image can be digitally enlarged to the desired digital zoom of 3×. This manner enables the user to capture more of the mountain range in the scene, as desired. Unfortunately, however, the digitally enlarged image utilizing this manner lacks the finer details of the bright green leaves that the user wished to capture. The missing details of the bright green leaves in the resulting image are an example of poor user experience. This document describes systems and techniques directed at fusing optically zoomed images into one digitally zoomed image to capture both the mountain range and the desired finer details of the leaves. The disclosed systems and techniques may address a user's desire to obtain an image that both represents a wide view of a scene while also containing fine details. The conflict between these demands may be addressed by the disclosed systems and techniques, which may provide a digitally zoomed image that may be considered enhanced in comparison to the optically zoomed images.

The following discussion describes operating environments and techniques that may be employed in the operating environments and example methods. Although systems and techniques for fusing optically zoomed images into one digitally zoomed image are described, it is to be understood that the subject of the appended Claims is not necessarily limited to the specific features or methods described. Rather, the specific features and methods are disclosed as example implementations and reference is made to the operating environment by way of example only.

### Operating Environment

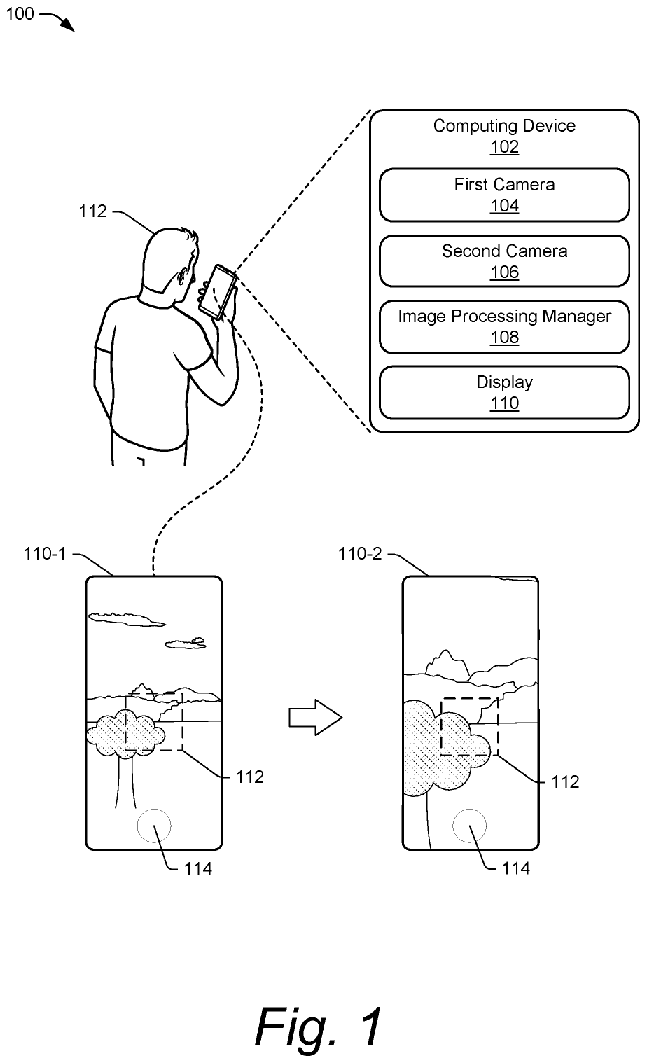

FIG. 1 illustrates an example implementation 100 of an example computing device 102. As shown, the computing device 102 includes a first camera 104, a second camera 106, an image-processing manager 108, and a display 110. The first camera 104 consists of a first lens configured to provide a first optical zoom of 1×, a wide FOV, and a deep depth of field (DOF). The first camera 104 having the wide FOV and deep DOF provides capabilities that are excellent for selfies with friends or capturing more of a scene in general. The second camera 106 consists of a second lens configured to provide a second optical zoom of 4×, a narrow FOV, and a shallow DOE The second camera 106 having the greater optical zoom provides features that are great for capturing wildlife or other scenes that are far away. Additionally, the first camera 104 and the second camera 106 do not share a same point of view (POV). The image-processing manager 108 is configured to fuse optically zoomed images into one digitally zoomed image.

In one example, a user 110 of the computing device 102 wants to take a photograph of a scene of bright green leaves on a branch of a tree. A mountain range is in a background of the scene. The user 110 wishes to capture the scene including portions of the mountain range in the background and at least some of the finer details of the bright green leaves on the branch in the foreground. To do so, the user 110 frames the scene, as shown by display 110-1, selects a desired digital zoom of 3×, as shown by display 110-2, taps a portion of the display to set a focus region 112 around the bright green leaves, and taps a shutter button 114 to capture the scene. As shown by the display 110-2, the scene at the digital zoom of 3× is blurry, lacking the finer details of the bright green leaves.

Responsive to the user 110 tapping the shutter button 114, the first camera 104 and the second camera 106 may capture a first image and a second image contemporaneously. After the images are captured, the image-processing manager 108 receives the first image from the first camera 104 at the 1× optical zoom and the second image from the second camera 106 at the 4× optical zoom. Based on the two images, the image-processing manager 108 determines an overlap region of the first image in which the second image overlaps the first image. In this example, because the user adjusted the focus region 112 to be around the bright green leaves, both the first image and the second image are focused on an area around the bright green leaves. The image-processing manager 108 may use the focus region 112 around the bright green leaves as the overlap region. Further, the image-processing manager 108 receives the selection, chosen by the user 110, of the desired digital zoom of 3×. Based on the first image and the second image, the image-processing manager 108 determines a fused image of the scene with the desired digital zoom of 3×. In the determining of the fused image, the image-processing manager 108 may apply a machine-learned (ML) model configured to compensate for the different FOVs, the different POVs, and the different DOFs of the two cameras. In some aspects, the ML model, or other appropriate systems and techniques, may enable the image-processing manager 108 to apply a higher resolution than the first image of the second image to the overlap region of the first image. Responsive to the determining of the fused image, the image-processing manager 108 provides the fused image of the scene having the desired digital zoom of 3× and the higher resolution than the first image within at least a portion of the overlap region.

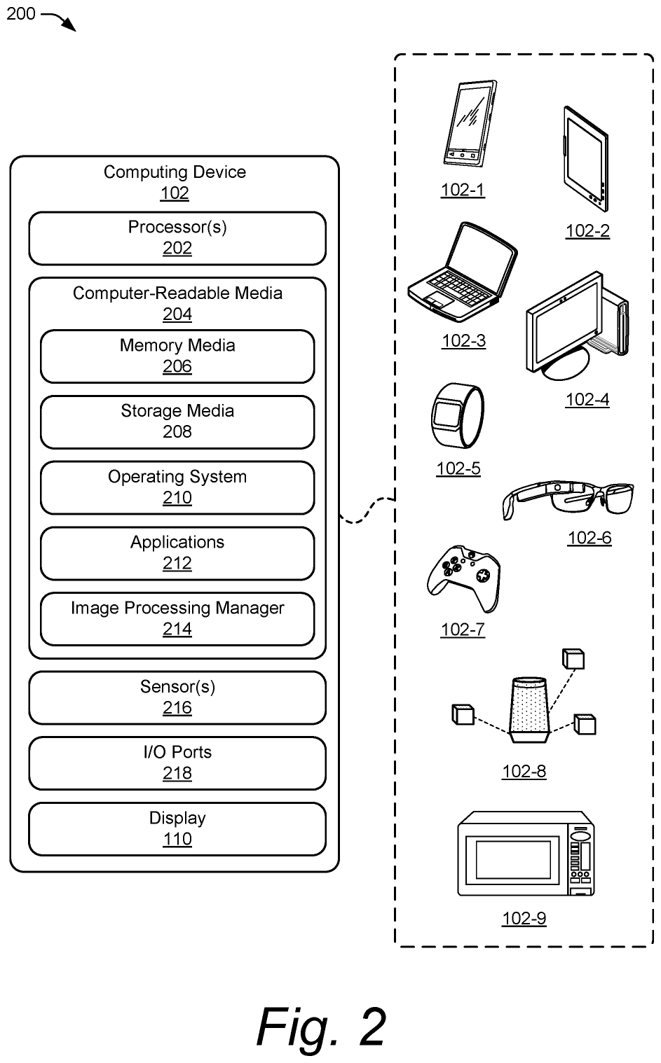

In more detail, FIG. 2 illustrates an example implementation 200 of the computing device 102 from FIG. 1, which is configured to fuse optically zoomed images into one digitally zoomed image. The computing device 102 is illustrated as a variety of example devices. As non-limiting examples, the computing device 102 can be a smartphone 102-1, a tablet 102-2, a laptop computer 102-3, a desktop computer 102-4, a smartwatch 102-5, a pair of smart glasses 102-6, a gaming controller 102-7, a smart home speaker 102-8, and a microwave 102-9. Although not shown, the computing device 102 may also be implemented as a health monitoring device, a personal media device, a drone, a home appliance, a security system, and the like. Note that the computing device 102 can be wearable, non-wearable but mobile, or relatively immobile (e.g., desktop computer 102-4, microwave 102-9). Also, note that the computing device 102 can be used with, or embedded within, many computing devices or peripherals, such as in automotive vehicles or as an attachment to a personal computer. The computing device 102 may include additional interfaces and components omitted from FIG. 2.

As illustrated, the computing device 102 includes one or more processors 202 and computer-readable media 204 (CRM 204). The processors 202 may include one or more of any appropriate processor (e.g., a central processing unit). The CRM 204 includes memory media 206 and storage media 208. The computing device 102 also includes an operating system 210 (OS 210), applications 212, and an image-processing manager 214 stored as computer-readable instructions on the CRM 204. The processor(s) 202 can execute the computer-readable instructions on the CRM 204 to provide some or all of the functionalities described herein. The CRM 204 may include one or more non-transitory storage devices such as random-access memory, a solid-state drive, a magnetic spinning drive, or any other type of storage media suitable for storing electronic instructions, each coupled with a data bus. The term “coupled” may refer to two or more elements that are in direct contact (physically, electrically, optically, etc.) or two or more elements that are not in direct contact with each other, but still cooperate and interact with each other.

In some implementations, the image-processing manager 214 can include one or more integrated circuits, a system on a chip, a secure key store, hardware embedded with firmware stored on read-only memory, a printed circuit board with various hardware components, or any combination thereof. As described herein, an image fusing system may include one or more components of the computing device 102, as illustrated in FIG. 2, configured to fuse optically zoomed images into one digitally zoomed image. In other implementations, the image fusing system may be implemented as the computing device 102.

Additionally, the computing device 102 includes one or more sensors 216, input/output (I/O) ports 218, and the display 110 from FIG. 1. The sensors 216 may be disposed anywhere on or in the computing device 102. In some examples, the sensors 216 may be disposed on or in a peripheral device connected to the computing device 102. The sensors 216 can include any of a variety of sensing components, such as an audio sensor (e.g., a microphone), a touch input sensor (e.g., a touchscreen), an image sensor (e.g., a camera, a video camera), an ambient light sensor (e.g., a photodetector), an acceleration sensor (e.g., an accelerometer), and so forth. The sensors 216 can enable the computing device 102 to automatically rotate content shown by the display 110, depending on an orientation of the computing device 102, measure an ambient light to adjust a brightness of the display 110, capture an image of a scene, and so forth. In implementations, the computing device 102 may include more than one of any one or more of the sensing components to enable a variety of features and functionalities.

The I/O ports 218 can enable the computing device 102 to interact with other devices or users through peripheral devices, transmitting any combination of digital signals and analog signals via wired manners (e.g., ethernet) or wireless manners (e.g., radio). The I/O ports 218 may include any combination of internal or external ports, such as universal serial bus (USB) ports, audio ports, video ports, and so forth. Various peripheral devices may be operatively coupled with the I/O ports 218, such as human input devices, external CRM, speakers, and displays.

The display 110 can be or utilize any one of a variety of display technologies, including an organic light-emitting diode display, a liquid crystal display, an electroluminescent display, and so forth. The display 110 may be referred to as a screen, such that content may be displayed on-screen. In an example, the on-screen content may be a viewfinder of a camera application.

Although not shown, the computing device can also include a system bus, interconnect, or other data transfer system that couples with the various components of or within the computing device 102. A system bus or interconnect can include any one or combination of various bus structures, such as a memory bus, a peripheral bus, a USB, and a processor or local bus.

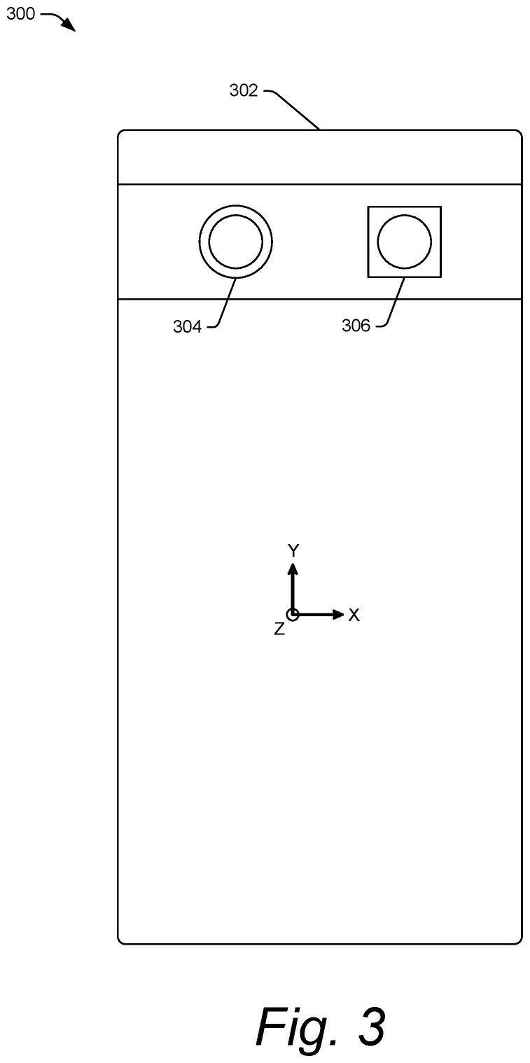

FIG. 3 illustrates a rear view of an example implementation 300 of a computing device 302 (e.g., computing device 102, smartphone 102-1) having the sensors 216 implemented as two separate image sensors (e.g., cameras). As illustrated, a first camera 304 and a second camera 306 are disposed in a back of a housing of the computing device 302. As shown, the first camera 304 and the second camera 306 reside in a same X-Y plane of the back of the housing of the computing device 302. Although not shown, the first camera 304 has a first lens configured to provide a first optical zoom of 1×, a wide FOV, and a deep DOF. The second camera 306 has a second lens configured to provide a second optical zoom of 4×, a narrow FOV, and a shallow DOF. The first camera 304 has a first POV and the second camera 306 has a second POV different from the first POV. Accordingly, any time a user (e.g., user 110) captures a scene with the computing device 302 having the two cameras, the first camera 304 captures the scene at the wide FOV, the deep DOF, and the first POV, and the second camera 306 captures the scene at the narrow FOV, the shallow DOF, and the second POV different from the first POV. To compensate for the different FOVs, DOFs, and POVs of the first and second cameras, the image-processing manager 108 may apply the ML model mentioned earlier.

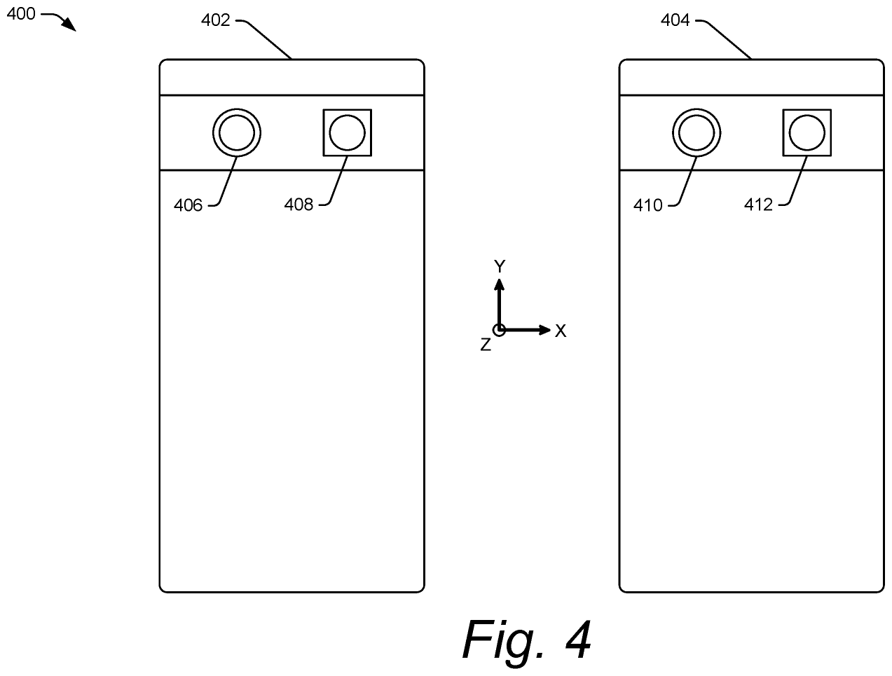

FIG. 4 illustrates a rear view of an example implementation 400 of an example setup for the training of the ML model. As illustrated, the setup comprises a first computing device 402 and a second computing device 404. The first computing device 402 and the second computing device 404 reside in a same X-Y plane. Like the computing device 302 from FIG. 3, the computing devices have two cameras. The first computing device 402 has a first training camera 406 and a second training camera 408. Similarly, the second computing device 404 has a first training camera 410 and a second training camera 412. Although not shown, the first training camera 406 and the first training camera 410 each have a lens configured to provide a first training optical zoom of 1×, a deep DOF, and a wide FOV. The second training camera 408 and the second training camera 412, although not shown, each have a lens configured to provide a second training optical zoom of 4×, a shallow DOF, and a narrow FOV.

The training of the ML model, for example, uses first, second, and third sets of many (e.g., hundreds, thousands) images. The first set of images is captured by the second training camera 408 of the first computing device 402 at the second training optical zoom of 4×, the shallow DOF, and the narrow FOV. The images in this first set of images may be referred to as reference images (e.g., a first training input). The second set of images is captured by the first training camera 410 of the second computing device 404 at the first training optical zoom of 1×, the deep DOF, and the wide FOV. The images in this second set of images may be referred to as source images (e.g., a second training input). The third set of images is captured by the second training camera 412 of the second computing device 404 at the second training optical zoom of 4×, the shallow DOF, and the narrow FOV. The images in this third set of images may be referred to as target output images (e.g., a third training input). Although the training of the ML model may use sets of many images, only a single image from each set of images will be referenced herein.

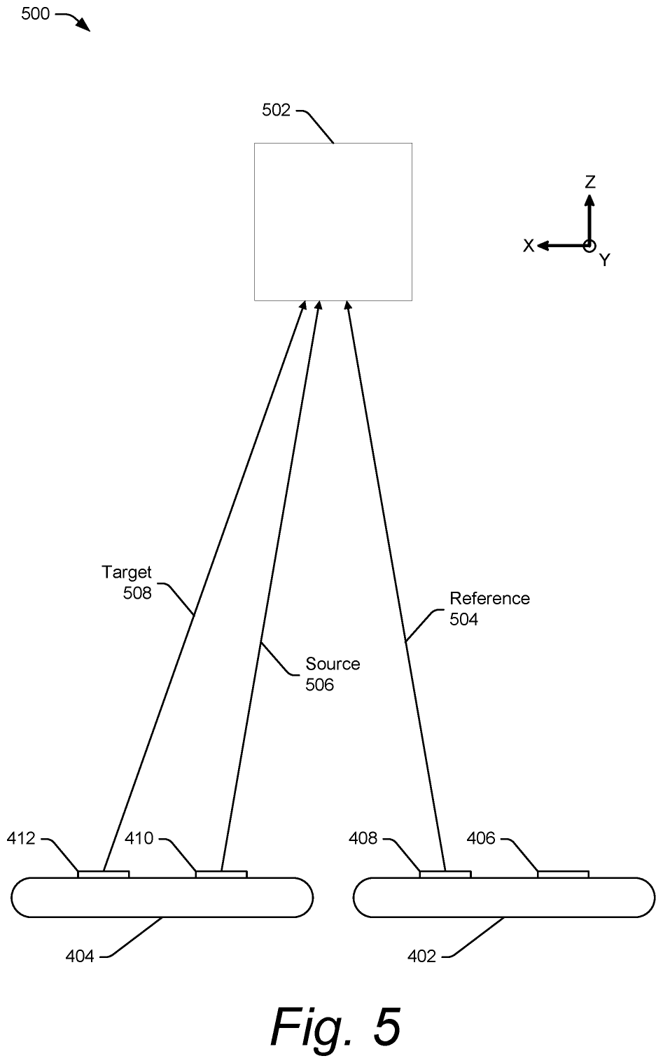

FIG. 5 shows a top-down view of an example implementation 500 of the training setup from FIG. 4 in more detail. As illustrated, the computing device 402 and the computing device 404 reside in a same X-Y plane and face in a same, positive Z direction toward a same scene of a cube 502, a top face of which is shown. Accordingly, the three training cameras reside in the same X-Y plane and face the same, positive Z direction toward the same scene of the cube 502. The first image (e.g., reference image) is captured from a first POV 504 by the second training camera 408 of the first computing device 402 at the second training optical zoom of 4×, the shallow DOF, and the narrow FOV. The second image (e.g., source image) is captured from a second POV 506 by the first training camera 410 of the second computing device 404 at the first training optical zoom of 1×, the deep DOF, and the wide FOV. The third image (e.g., target output image) is captured from a third POV 508 by the second training camera 412 of the second computing device 404 at the second training optical zoom of 4×, the shallow DOF, and the narrow FOV.

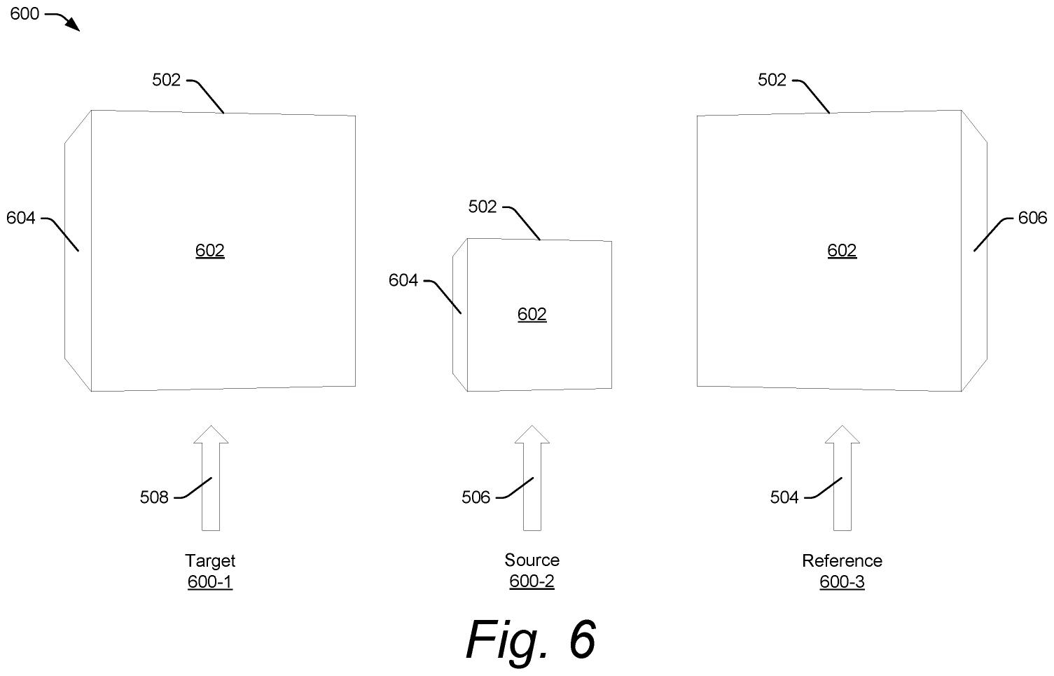

FIG. 6 shows an example implementation 600 of images of the same scene of the cube 502 captured by the three training cameras from FIG. 5. Detail view 600-1 shows the target output image of the scene of the cube 502 as captured by the second training camera 412 of the second computing device 404. Detail view 600-2 shows the source image of the scene of the cube 502 as captured by the first training camera 410 of the second computing device. Detail view 600-3 shows the reference image of the scene of the cube 502 captured by the second training camera 408 of the first computing device 402. As illustrated in detail view 600-1, from the third POV 508, the second training camera 412 captures an image of a front face 602 and a left face 604 of the cube 502 at the 4× training optical zoom. As illustrated in detail view 600-2, from the second POV 506, the first training camera 410 captures an image of the front face 602 and the left face 604 of the cube 502 at the 1× training optical zoom. As illustrated in detail view 600-3, from the first POV 504, the second training camera 408 captures an image of the front face 602 and a right face 606 of the cube 502 at the 4× training optical zoom.

FIG. 6 highlights that, depending on a POV (e.g., POV 508, POV 504) of a camera (e.g., training camera 412, training camera 408), different faces (e.g., left face 604, right face 606) of the cube 502 may be captured. FIG. 6 also highlights that, depending on an optical zoom (e.g., 1×, 4×) and a FOV of a camera, the cube 502 can appear large or small. To fuse optically zoomed images into one digitally zoomed image, the ML model is trained to compensate for the different optical zooms and FOVs in two operations: a coarse alignment operation and a fine alignment operation.

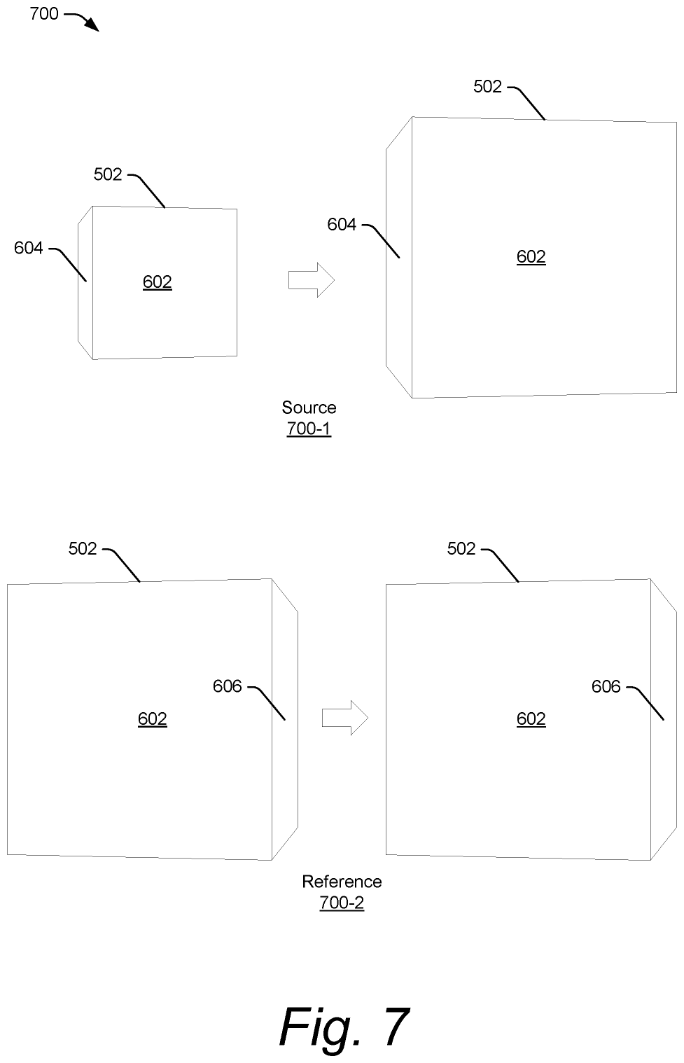

FIG. 7 shows an example implementation 700 of training the ML model to perform the coarse alignment operation. The coarse alignment operation comprises warping the source image and the reference image to align to the target output image. The warping comprises cropping, enlarging, and rotating the source image and the reference image. The course alignment may also include feature matching and global homography, which relates two images of a same scene from different POVs by how features in a first image may be in a different location in a second image (e.g., how pixels “move” between the images). Detail view 700-1 illustrates the warping of the source image of the cube 502. In this example, the warping simply comprises enlarging the source image of the cube 502 to match the size of the target output image of the cube 502 from detail view 600-1. Detail view 700-2 illustrates the warping of the reference image of the cube 502. In this example, because the reference image used the 4× training optical zoom like the target output image, enlarging is not necessary. However, detail view 700-2 of the reference image highlights, when compared to detail view 600-1, that the left side 604 is not visible. This is a result of the different POVs of the cameras used to capture the images. To account for this, the ML model is also trained to compensate for the different POVs using an occlusion mask operation.

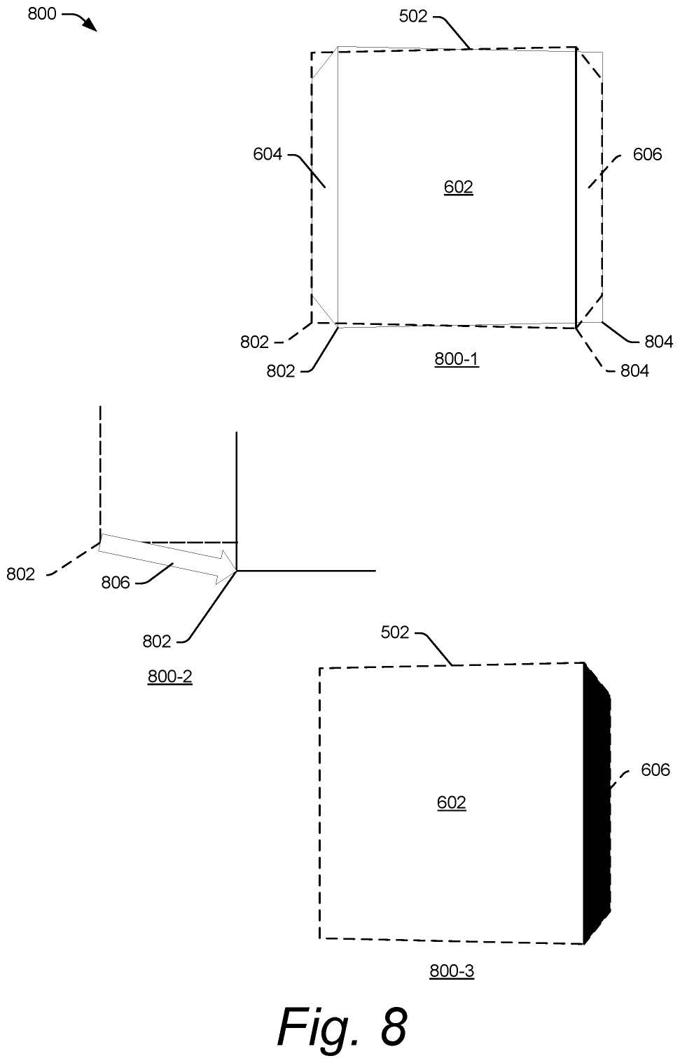

FIG. 8 illustrates an example implementation 800 of training the ML model to perform the fine alignment operation. Detail view 800-1 illustrates the reference image of the cube 502, using dashed lines, overlaid on the target output image of the cube 502, using solid lines. As illustrated, a bottom left corner 802 of the front face 602 of the cube 502 is not in a same position in the two images. Likewise, a bottom right corner 804 of the front face 602 of the cube 502 is not in a same position in the two images. Detail view 800-2 shows an enlarged view of the bottom left corner 802 of the front face 602 of the cube 502. A movement 806 of the bottom left corner 802 from the reference image (dashed line) to the target output image (solid line) is highlighted. Although only the movement 806 of the bottom left corner 802 is shown, a movement of every pixel from the reference image to the target output image may be calculated by an existing convolutional neural network (CNN) (e.g., PWC-Net). An output, which describes the movement of every pixel, may be called an optical flow. The optical flow may be stored as a heatmap and can be used in the training of the ML model to perform the fine alignment operation.

FIG. 8 also shows, in detail view 800-3, an example of training the ML model to perform the occlusion mask operation. As shown, the right face 606 of the cube 502 from the reference image is filled in black. This is the occlusion mask, which highlights portions of an image (e.g., the reference image, the source image) that are not visible in another image (e.g., the target output image). The occlusion mask can be used in the training of the ML model to compensate for the different POVs of the cameras. In the fusing of the source image and the reference image, details of the reference image not covered by an occlusion mask (e.g., not filled in black) may be transferred to the source image.

The occlusion mask can also be used in the training of the ML model to transfer details of the reference image to the source image based on a combination of losses. The training of the ML model to transfer these details based on the combination of losses is performed using a luma (e.g., grayscale) channel to avoid color shifts. A first transfer of details is a visual geometry group CNN (VGGNet) transfer of details. The VGGNet excels at object recognition (e.g., groups of details that make up an object). Equation 1 defines the VGGNet transfer of details using the fused image (fused), the target output image (target), and the occlusion mask (occ_mask).

$$VGGNet\_transfer = VGG\_loss ( fused \vert target ) * ( 1 - occ\_mask ) \qquad Equation 1$$

A second transfer of details is a least absolute deviations (L1) transfer of details. However, the second transfer of details is not a pure L1 transfer of details because that may result in a large luma shift. Accordingly, a gaussian blur (blur) is applied to the source image (source) and the fused image to avoid the large luma shift. Equation 2 defines the L1 transfer of details.

$$L 1 \_transfer = L 1 \_loss [ blur ( source ) \vert blur ( fused ) ] * ( 1 - occ\_mask ) \qquad Equation 2$$

A third transfer of details is a contextual transfer of details. The contextual transfer of details excels at further aligning non-aligned regions between the fused image and the target output image. Equation 3 defines the contextual transfer of details.

$$contextual\_transfer = contextual\_loss ( fused \vert target ) * ( 1 - occ\_mask ) \qquad Equation 3$$

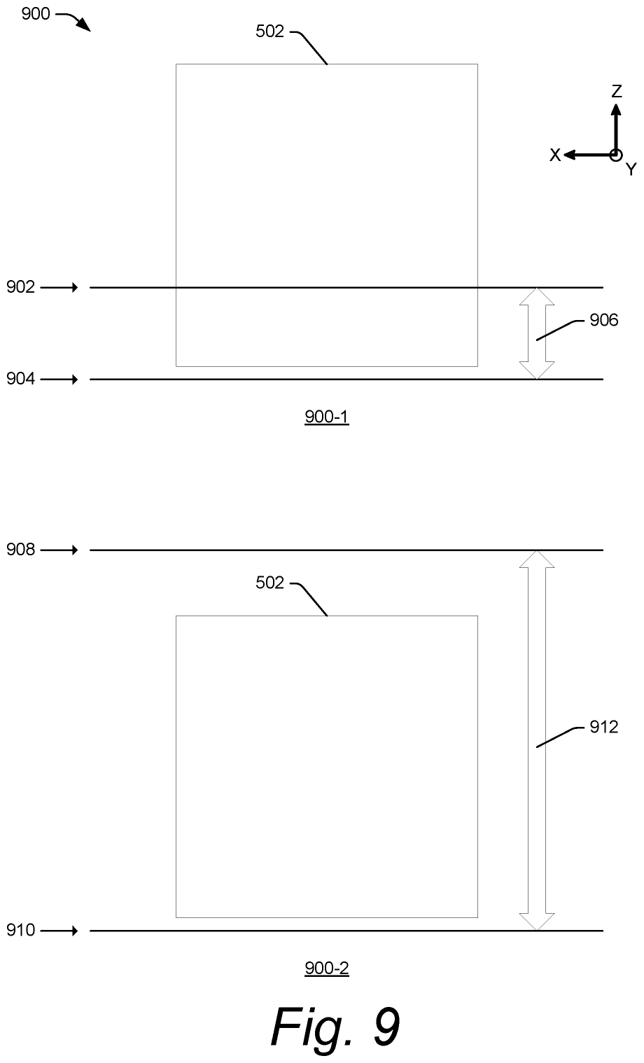

Recall momentarily that the 1× training optical zoom camera and the 4× training optical zoom camera do not share a same DOF. FIG. 9 shows a top-down view of an example implementation 900 of training the ML model to compensate for the different DOFs. Detail view 900-1 illustrates the top face of the cube 502, a reference line 902, and a reference line 904. The reference line 902 shows an X-Y plane at which the farthest objects (e.g., the cube 502) in the scene are in focus. The reference line 904 shows an X-Y plane at which the nearest objects in the scene are in focus. A DOF 906 between the reference lines is the distance between the nearest and the farthest objects in the scene that are in focus when the scene is captured by the camera at the 4× optical zoom. Similarly, detail view 900-2 illustrates the top face of the cube 502, a reference line 908, and a reference line 910. The reference line 908 shows an X-Y plane at which the farthest objects in the scene are in focus. The reference line 910 shows an X-Y plane at which the nearest objects in the scene are in focus. A DOF 912 between the reference lines is the distance between the nearest and the farthest objects in the scene that are in focus when the scene is captured by the camera at the 1× optical zoom. As illustrated in detail view 900-1, the DOF 906 of the 4× optical zoom camera is shallow and the DOF 912, illustrated in detail view 900-2, of the 1× optical zoom camera is deep. The difference in the DOFs results in different portions of the scene of the cube 502 being in focus in the source image and the reference image.

When fusing the optically zoomed images (the source image and the reference image) into the one digitally zoomed image (a digitally enlarged source image), the ML model is trained not to transfer details that are out of focus. To do this, the ML model may utilize a defocus map. The defocus map and its application may be described by two equations. Equation 4 defines the defocus map.

$$defocus\_map ( x , y ) = \vert flow ( x , y ) - arg max [ P ( f ) ] \vert \qquad Equation 4$$

The defocus map (map(x,y)) is a function of the optical flow of the entire image (flow(x,y)) and the distribution of the optical flow of the focus region (e.g., focus region 112) of the image (P(f)). A focused optical flow within the focus region (argmax[P(f)]) is calculated using k-means clustering. The difference between flow(x,y) and argmax[P(f)] calculates if an area of the image is in focus, the difference being set as the defocus map. The defocus map may be applied to the transfer of details from the reference image, at the 4× optical zoom, to the source image, at the 1× optical zoomed, via a defocus mask. Equation 5 defines the defocus mask.

$$defocus\_mask ( x , y ) = sigmoid [ defocus\_map ( x , y ) - do ] \qquad Equation 5$$

The defocus mask (mask(x,y)) is the sigmoid of the difference of the defocus map and a tunable parameter (do).

To avoid color shift in the fusing of optically zoomed images into one digitally zoomed image, both the reference image and the target output image are set to match the color of the source image. The colors are set using global mean and standard deviation color matching methods.

To avoid a poorly fused image in the fusing of optically zoomed images into one digitally zoomed image, a set of fallback conditions may be set. The fallback conditions may include a low light environment, a large error in reprojection of details from the reference image to the source image, a large base frame delta, and an out-of-focus reference image.

Although techniques herein have been described in reference to, or for use by, a computing device having a first camera paired with a lens capable of a 1× optical zoom and a second camera paired with a lens capable of a 4× optical zoom, at least some of the aforementioned techniques can also be implemented by other computing devices. For example, a computing device having a first camera paired with a lens capable of 1× optical zoom, a second camera paired with a lens capable of a 4× optical zoom, and a third camera paired with a lens capable of a 10× optical zoom may implement the aforementioned techniques. The techniques can be applied to fuse an image captured by the 4× optical zoom camera and the 10× optical zoom camera into a 6× digital zoom image, for example.

### Example Methods

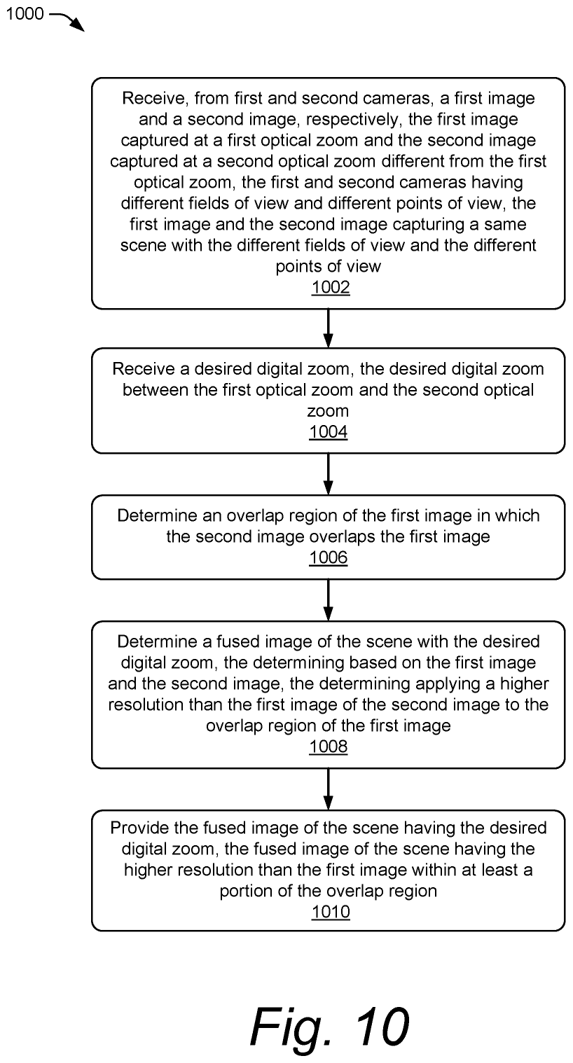

FIG. 10 depicts method 1000, which enables the fusing of optically zoomed images into one digitally zoomed image. The method is shown as sets of blocks that specify operations performed but are not necessarily limited to the order or combinations shown for performing the operations by the respective blocks. Further, any of one or more of the operations may be repeated, combined, reorganized, or linked to provide a wide array of additional or alternate methods. In portions of the following discussion, reference may be made to the example implementation of FIG. 1 and details and examples in FIGS. 2-9, reference to which is made for example only. The techniques are not limited to performance by one entity or multiple entities operating on one device.

At 1002, an image-processing manager (e.g., image-processing manager 108) receives, from first and second cameras, a first image and a second image, respectively, the first image captured at a first optical zoom and the second image captured at a second optical zoom different from the first optical zoom, the first and second cameras having different fields of view and different points of view, the first image and the second image capturing a same scene with the different fields of view and different points of view.

At 1004, the image-processing manager receives a desired digital zoom, the desired digital zoom between the first optical zoom and the second optical zoom. For example, the first optical zoom could be 1× or lower (e.g., 0.5×, 0.7×) and the second optical zoom could be 4× or greater (e.g., 5×, 6×). The desired digital zoom, accordingly, could be anywhere from 1× or lower to 4× or greater (e.g., 2×, 3×), exclusive. Receiving the desired digital zoom may comprise receiving a selection of a digital zoom by a user.

At 1006, the image-processing manager determines an overlap region of the first image in which the second image overlaps the first image. In an example, the overlap region could be a focus region that a user selects before capturing an image of a scene. The focus region may indicate to the first camera and the second camera an area of the scene on which the cameras should focus, utilizing an autofocus optical system, for example.

At 1008, the image-processing manager determines a fused image of the scene with the desired digital zoom, the determining based on the first image and the second image, the determining applying a higher resolution than the first image of the second image to the overlap region of the first image.

At 1010, the image-processing manager provides the fused image of the scene having the desired digital zoom, the fused image of the scene having a higher resolution than the first image within at least a portion of the overlap region. For example, as illustrated in FIG. 1, the higher resolution could be the details of the leaves captured by the second camera at the second optical zoom of 4×. The fused image of the scene may be provided for display, for example, by the display 110 of the computing device 102.

### Additional Examples

In the following section, additional examples are provided.

Example 1: A method comprising: receiving, from first and second cameras, a first image and a second image, respectively, the first image captured at a first optical zoom and the second image captured at a second optical zoom different from the first optical zoom, the first and second cameras having different fields of view and different points of view, the first image and the second image capturing a same scene with the different fields of view and the different points of view; receiving a desired digital zoom, the desired digital zoom between the first optical zoom and the second optical zoom; determining an overlap region of the first image in which the second image overlaps the first image; determining a fused image of the scene with the desired digital zoom, the determining based on the first image and the second image, the determining applying a higher resolution than the first image of the second image to the overlap region of the first image; and providing the fused image of the scene having the desired digital zoom, the fused image of the scene having the higher resolution than the first image within at least a portion of the overlap region.

Example 2: The method as described in example 1, wherein the first and second cameras are different cameras in a shared camera array.

Example 3: The method as described in example 1, wherein the first and second cameras are separate cameras housed within a same mobile computing device, the separate cameras each having different lenses.

Example 4: The method as described in example 3, wherein the different lenses are configured to provide the first optical zoom and the second optical zoom.

Example 5: The method as described in example 4, wherein the first optical zoom is 1× or lower, the second optical zoom is 2× or greater, and the desired digital zoom is between the first optical zoom of 1× or lower and the second optical zoom of 2× or greater, exclusive.

Example 6: The method as described in example 1, wherein the first image and the second image are captured contemporaneously.

Example 7: The method as described in example 1, wherein receiving the desired digital zoom receives a selection of a digital zoom by a user of a mobile computing device associated with the first and second cameras.

Example 8: The method as described in any one of the previous examples, further comprising receiving the desired digital zoom prior to receiving the first image and the second image, and wherein receiving the first and second images comprises causing the first and second cameras to capture the first and second images, respectively, responsive to receiving the desired digital zoom.

Example 9: The method as described in any one of the previous examples, wherein determining the fused image of the scene with the desired digital zoom applies a machine-learned model, the machine-learned model configured to compensate for the different fields of view of the first image and the second image.

Example 10: The method as described in any one of any of the previous examples, wherein determining the fused image of the scene with the desired digital zoom applies a machine-learned model, the machine-learned model configured to compensate for the different points of view of the first image and the second image.

Example 11: The method as described in example 10, wherein compensating for the different points of view generates an occlusion mask, the occlusion mask highlighting portions of the second image that are not shared by the first image.

Example 12: The method as described in example 11, wherein determining the fused image of the scene with the desired digital zoom copies details not highlighted by the occlusion mask from the second image to the first image.

Example 13: The method as described in any one of any of the previous examples, wherein the machine-learned model is trained by first, second, and third sets of images, the first set of images captured by a first training camera at a first training optical zoom, the second set of images captured by a second training camera at a second training optical zoom different from the first training optical zoom, and the third set of images captured by a third training camera at a same training optical zoom as the first training optical zoom.

Example 14: The method as described in example 13, wherein the first training camera and the second training camera are physically separate and disparately located cameras.

Example 15: The method as described in example 13, wherein the first and second training cameras capture the first and second sets of images while facing a same direction from a same plane.

Example 16: The method as described in example 13, wherein the first training optical zoom is greater than the second training optical zoom.

Example 17: The method as described in example 13, wherein the first set of images and the second set of images are input images and the third set of images includes a target output image.

Example 18: A computing device comprising: at least two cameras, the at least two cameras having different optical zooms, different fields of view, and different points of view; one or more processors; and memory storing: instructions that, when executed by the one or more processors, cause the one or more processors to implement an image-processing manager to provide image processing utilizing the at least two cameras and the one or more processors by performing the method of any one of the preceding examples.

Example 19: A computer-readable medium comprising instructions that, when executed by one or more processors, cause the one or more processors to carry out the method of any one of the examples 1 to 17.

### CONCLUSION

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

Although implementations for fusing optically zoomed images into one digitally zoomed image have been described in language specific to certain features and/or methods, the subject of the appended Claims is not necessarily limited to the specific features or methods described. Rather, the specific features and methods are disclosed as example implementations for fusing optically zoomed images into one digitally zoomed image.

1. A method comprising:
receiving, from first and second cameras, a first image and a second image, respectively, the first image captured at a first optical zoom and the second image captured at a second optical zoom different from the first optical zoom, the first and second cameras having different fields of view and different points of view, the first image and the second image capturing a same scene with the different fields of view and the different points of view;
receiving a desired digital zoom, the desired digital zoom being between the first optical zoom and the second optical zoom;
determining an overlap region of the first image in which the second image overlaps the first image;
determining a fused image of the scene with the desired digital zoom, the determining based on the first image and the second image, the determining applying a higher resolution than the first image of the second image to the overlap region of the first image; and
providing the fused image of the scene having the desired digital zoom, the fused image of the scene having the higher resolution than the first image within at least a portion of the overlap region.

2. The method as described in claim 1, wherein the first and second cameras are separate cameras in a shared camera array, the separate cameras each having different lenses.

3. The method as described in claim 1, wherein the first and second cameras are separate cameras housed within a same mobile computing device, the separate cameras each having different lenses.

4. The method as described in claim 3, wherein the different lenses are configured to provide the first optical zoom and the second optical zoom.

5. The method as described in claim 4, wherein the first optical zoom is 1× or lower, the second optical zoom is 2× or greater, and the desired digital zoom is between the first optical zoom of 1× or lower and the second optical zoom of 2× or greater, exclusive.

6. The method as described in claim 1, wherein the first image and the second image are captured contemporaneously.

7. The method as described in claim 1, wherein receiving the desired digital zoom comprises receiving a selection of a digital zoom by a user of a mobile computing device associated with the first and second cameras.

8. The method as described in claim 1, further comprising receiving the desired digital zoom prior to receiving the first image and the second image, and wherein receiving the first and second images comprises causing the first and second cameras to capture the first and second images, respectively, responsive to receiving the desired digital zoom.

9. The method as described in claim 1, wherein determining the fused image of the scene with the desired digital zoom applies a machine-learned model, the machine-learned model configured to compensate for the different fields of view of the first image and the second image.

10. The method as described in claim 1, wherein determining the fused image of the scene with the desired digital zoom applies a machine-learned model, the machine-learned model configured to compensate for the different points of view of the first image and the second image.

11. The method as described in claim 10, wherein compensating for the different points of view generates an occlusion mask, the occlusion mask highlighting portions of the second image that are not shared by the first image.

12. The method as described in claim 11, wherein determining the fused image of the scene with the desired digital zoom copies details not highlighted by the occlusion mask from the second image to the first image.

13. The method as described in claim 9, wherein the machine-learned model is trained by first, second, and third sets of images, the first set of images captured by a first training camera at a first training optical zoom, the second set of images captured by a second training camera at a second training optical zoom different from the first training optical zoom, and the third set of images captured by a third training camera at a same training optical zoom as the first training optical zoom.

14. The method as described in claim 13, wherein the first training camera and the second training camera are physically separate cameras.

15. The method as described in claim 13, wherein the first and second training cameras capture the first and second sets of images while facing a same direction from a same plane.

16. The method as described in claim 13, wherein the first training optical zoom is greater than the second training optical zoom.

17. The method as described in claim 13, wherein the first set of images and the second set of images are input images and the third set of images includes a target output image.

18. A computing device comprising:
at least two cameras, the at least two cameras having different optical zooms, different fields of view, and different points of view;
one or more processors; and
memory storing:
instructions that, when executed by the one or more processors, cause the one or more processors to implement an image-processing manager to provide image processing utilizing the at least two cameras and the one or more processors by performing the method of any one of the preceding claims.

19. A computer-readable medium comprising instructions that, when executed by one or more processors, cause the one or more processors to carry out operations comprising:
receiving, from first and second cameras, a first image and a second image, respectively, the first image captured at a first optical zoom and the second image captured at a second optical zoom different from the first optical zoom, the first and second cameras having different fields of view and different points of view, the first image and the second image capturing a same scene with the different fields of view and the different points of view;
receiving a desired digital zoom, the desired digital zoom being between the first optical zoom and the second optical zoom;
determining an overlap region of the first image in which the second image overlaps the first image;
determining a fused image of the scene with the desired digital zoom, the determining based on the first image and the second image, the determining applying a higher resolution than the first image of the second image to the overlap region of the first image; and
providing the fused image of the scene having the desired digital zoom, the fused image of the scene having the higher resolution than the first image within at least a portion of the overlap region.
